(19) United States
(12) Patent Application Publication
(10) Pub. No.: US 2009/0251391 A1
(43) Pub. Date: Oct. 8, 2009

(54) Method and apparatus for power recycling in a display system

(75) Inventors: Ricky Chung Yee Ng, Hong Kong (HK); Felix Wai Yu Wong, Hong Kong (HK); Kenneth Chi Wai Lee, Hong Kong (HK); Stephen Wai-Yan Lai, Hong Kong (HK); Johnkid Lo, Hong Kong (HK)

Correspondence Address: Fay Sharpe LLP, 1228 Euclid Avenue, 5th Floor, The Halle Building, Cleveland, OH, 44115, US

(73) Assignee: Solomon Systech Limited, Hong Kong (HK)

(21) Appl. No.: 12/080,297

(22) Filed: Apr. 2, 2008

(51) Int. Cl. G09G 3/30

(52) U.S. Cl. 345/76

(57) ABSTRACT

A power recycling method and apparatus for driving capacitive display elements are described. The driving process involves charging and discharging the display elements. More particularly, the method effectively reuses some of the energy during the discharging process. Energy in display elements flows back from the panel to a power supply and other optionally to devices like RAM, MCU directly during the discharging process. Diodes between one or more power supplies and the display elements ensure that the discharge paths are disconnected when the voltage of display elements drops below the voltage of the power supply. A resistor path from the display elements to ground or a power supply lower than the display threshold voltage of the display elements guarantees that elements are turned OFF after the discharge process.

### TECHNICAL FIELD

The present invention relates to a power recycling method and apparatus for driving a display. The driving process involves charging and discharging the display elements. More particularly, the invention is directed to effectively reuse some of the energy during the discharging process.

### BACKGROUND

A typical electroluminescence (EL) display is an apparatus based on a panel of electroluminescence elements organized in a two-dimensional matrix of rows and columns. In general, each of the electroluminescence elements of the display has two electrodes of opposite electrical polarity: an anode and a cathode. One of the electrodes is connected to a row line while the other to a column line of the driving circuitry of the system. Each of the electroluminescence elements in the matrix is located where the addressing row and column lines for that particular element intersect.

An electroluminescence element emits light when the element conducts electric current and a voltage across the anode and cathode of the element is supplied in the forward polarity—a positive voltage to the anode and a negative voltage to the cathode. Intensity of the light emitted is determined by the magnitude of the current, which is related to the voltage applied across the electrodes.

In operation, a driving scheme is employed to display data on the panel of the two-dimensional matrix of an electroluminescence display. A typical driving scheme for driving such an electroluminescence display involves sequentially activating each and every one of either rows or columns of the electroluminescence elements in the matrix, one at a time in a scanning manner. While each row or column is activated, selected elements in the activated row or column are then turned on via established electrical routes to the power source of the driving system so that the elements can be energized and emit light. The addressed elements are activated sequentially in repeated scanning cycles at a speed sufficiently fast that the sequentially light emitting elements appear to the human eyes as being lit simultaneously and continuously, allowing for a properly perceived image.

A common driving scheme in such electroluminescence displays is one that scans the rows in the matrix of display elements. Display element rows in the matrix are addressed one after another sequentially. Meanwhile, appropriate power or ground sources drive the element columns so as to activate or deactivate the electroluminescence elements respectively in accordance with the requirement of the image data to be displayed.

FIG. 4 is a schematic diagram illustrating the circuit configuration of a conventional driving system 400 for an electroluminescence display panel. The panel exemplified here has a matrix of 64 rows by 132 columns of display elements. In the matrix, each element is designated as elements E_{C.R}, wherein the subscript “C” identifies the column and “R” the row positional designation. In the entire matrix consisting of E_{1.1}-E_{132.64}, anodes of each column of the electroluminescence display elements are electrically connected together and to their respective anode lines A₁-A₁₃₂. In a similar arrangement, cathodes of each row of the elements are connected to their respective cathode lines B₁-B₆₄.

As depicted, one among the 64 display element rows, namely the top row with elements connected to the cathode line B₁ in the depicted example, is activated by connection to ground via its assigned cathode line scanning switch 5₁ of the cathode line scanning circuit 1. Meanwhile, all the other elements in cathode lines B₂-B₆₄ remain de-activated by connection to power Vcc via their respective cathode line scanning switches 5₂-5₆₄. The cathode line scanning circuit 1 is essentially an array of switches that is responsible for connecting the rows of display elements alternatively to power and ground voltages of the system.

Anode line driving circuit 2, essentially an array of switches for connecting the display element columns to the power source Vcc, activates selected ones of the display element columns by connecting them to their respectively-assigned ones of the current sources 2₁-2₁₃₂. Such connection is achieved by switching control of the anode line driving switches 6₁-6₁₃₂. Columns to be de-activated are instead connected to ground through anode line resetting switches 7₁-7₁₃₂ in the anode line resetting circuit 3, which is essentially an array of switches used to selectively connect the columns to ground.

The switching operation of the cathode line scanning switches 5₁-5₆₄ in the cathode line scanning circuit 1 is basically in a sequential and cyclic repeating manner. By contrast, switching operation of the anode line driving switches 6₁-6₁₃₂ in the anode line driving circuit 2 and switches 7₁-7₁₃₂ in the anode line resetting circuit 3 are in synchronism in accordance with the column data of the image to be displayed.

For example, in the system 400 of FIG. 4, elements E_{1.1} and E_{2.1} emit light while the other elements are turned off. In order for elements E_{1.1} and E_{2.1} to be turned on and emit light, switches 6₁ and 7₁ corresponding to the anode line A₁ must be switched in synchronization while their row, the one at cathode line B₁, is scanned. The same applies to switches 6₂ and 7₂.

Off elements include those uncharged ones such as E_{3,1} and charged ones such as E_{3,2}. In the drawings, turned-on display elements are represented by the symbol of a light-emitting diode, and turned-off elements are represented by the symbol of a capacitor, with charged elements expressed as symbols of capacitors with shading (e.g., E_{3,3}), and partially-charged and uncharged ones as regular capacitors (e.g., E_{2,3}). The charged and uncharged status of these turned-off display elements depends on the magnitude of the electric potential present across the electrodes of the elements.

In an electroluminescence display, parasitic capacitance inherent in the display elements represents a major problem. Because of large capacitive loading on the lines as well as the effect of charge storage, the quality of a displayed image deteriorates when light emission time duration for any particular element becomes non-uniform in the repeated frame cycles as a result of different image patterns. A phenomenon of off elements being induced to emit slightly due to signal cross-coupling under large-capacitance load switching conditions also degrades the display quality.

U.S. Pat. No. 5,844,368 issued on Dec. 1, 1998 to Okuda et al. and entitled “Driving system for driving luminous elements” described a system that attempts to minimize such problems by forcing rows and columns to definite supply levels to achieve certain reference situations before activation of the elements. However, the large panel capacitance is charged and discharged by supplying large switching currents from the power sources. When a row is scanned, those ON pixels of the row are charged. Due to the parasitic capacitance of the electroluminous elements of these pixels, significant energy is stored in these pixels. When the scanning of this row is completed, these ON pixels are discharged, and the stored energy is released. If the stored energy is simply discharged to system ground level, the discharging process wastes a substantial amount of energy.

U.S. Pat. No. 6,501,226 issued to Lai et al. on Dec. 31, 2002 entitled “Driving system and method for electroluminescence display” described a power retaining and recycling method. The driving scheme sequentially scans each of the lines. During interval of scanning two adjacent lines, a control circuit equalizes electric charges in electroluminescence elements, which turn the elements ON and OFF alternatively by electrically connecting these elements together before activation of the elements. In FIG. 5a, dotted lines represent a corresponding discharge process, and solid lines represent a charge process. The discharge process decreases the voltage level of a pixel in Row N from V1 down to V0, while a charge process increases the voltage of a pixel in Row N+1 from V0 to V1. After this charge recycling process, voltage across these elements reaches around a mid-level between the V1 and V0 before starting the charging or discharging process for the elements. In the above scheme, about half of the stored electric charge may be conserved and recycled, saving about half the electric charge that otherwise must supplied by the system power source. However, the above method is ineffective for some display scenarios.

Firstly, for some display images, some rows have no (or very few) ON-pixel elements. The stored energy cannot be effectively retained by sharing the energy within ON-pixels elements in adjacent row.

Secondly, the above method also does not work on pulse-width-modulation (PWM) type grayscale displays. As shown in FIG. 6, PWM is a method of driving a display's grayscale pixels by modulating the illumination duration when a pixel is selected. An array 640 of pixel elements is configured in rows Y1 to Y3 and columns X1 to X3. Pixels 11, 12 and 13 are in column X1 at rows Y1, Y2 and Y3, respectively. The selecting voltages are applied to rows Y1 to Y3, and the driving voltage signal is applied (as depicted) to column X1. The longer a pixel illuminates when the pixel is selected by a pulse 600, 610, and 620 of the selecting voltage signal, the brighter the pixel display appears. The illumination duration of a pixel is determined by the duration that a driving voltage signal 630 is applied to the pixel. As for the scenario shown in FIG. 6, the brightness of the pixel 11 is greater than that of the pixel 13, and the brightness of the pixel 13 is greater than that of the pixel 12. This can be seen by the ON pulse of the selecting voltage and the pulse width of the corresponding pulse of the driving voltage signal 630. This is a result of the corresponding pulse widths of the driving voltage signal 630. PWM enables the display of grayscale image on an electroluminescence display panel 640. However, in PWM type grey scale display, the discharge process of the previous row takes place before scanning of the next row. Thus before the charging of the next row, all charge of the previous row must be released. Therefore, charge sharing between a row and the next row cannot occur.

U.S. Pat. No. 6,556,177 issued to Katayama on Apr. 29, 2003 and entitled “Driver circuit for capacitive display elements” describes a power retaining and recycling method. A condenser, which can be charged or discharged, is connected to the electroluminescence display panel. This condenser is outside the driver IC. During a discharging process, a portion of energy from the EL element flows back to charge up the condenser for use in the next charging process. Thus, the energy is recycled in this manner.

The above method enables the application of the charge recycling in the PWM type grayscale display, because the power can be stored during the time interval between the previous discharging and the next charging. However, the introduction of the condenser, typically capacitors which require a lot of circuit size to implement, considerably increases circuit size. Further, the above method is not effective in Organic Light-Emitting Diode (OLED) applications, because the voltage level after the discharging and the rate of the discharging is fixed, and the circuit of the condenser must be designed specifically for different applications to guarantee voltage level after the discharging is lower than the operating turn-on voltage (display threshold voltage) of electroluminescence elements to turn off EL elements after the discharging process.

Therefore, a need exists of a effective and simple driving power recycling method that minimizes circuit size and is compatible for various applications such as driving a EL display or OLED display.

### SUMMARY OF THE INVENTION

It is a primary object of this invention to overcome the shortcoming of known existing driving method for capacitive display elements and provide a power recycling method that can efficiently recycle the energy in a discharge process of the display elements, such as OLED display and EL display.

Accordingly, aspects of the present invention have been developed with a view to substantially eliminate the drawbacks described hereinbefore and to provide low complexity architecture of a power recycling circuit for driving capacitive display elements.

The claimed invention relates to a power recycling method and apparatus for driving capacitive display elements are described. The driving process involves charging and discharging the display elements. More particularly, the method effectively reuses some of the energy during the discharging process.

Energy in display elements flows back from the panel to a power supply and other optionally to devices like RAM, MCU directly during the discharging process. Diodes between one or more power supplies and the display elements ensure that the discharge paths are disconnected when the voltage of display elements drops below the voltage of the power supply. A resistor path from the display elements to ground or a power supply lower than the display threshold voltage of the display elements guarantees that elements are turned OFF after the discharge process.

Other aspects will be apparent from the following description.

### BRIEF DESCRIPTION OF THE DRAWINGS

Embodiments of the invention are described in more detail hereinafter with reference to the drawings, in which:

FIG. 1 is a schematic diagram of a driver circuit for an OLED matrix display in accordance with an embodiment of the invention;

FIG. 2 is a schematic diagram of an embodiment of the driver circuit according to the invention;

FIG. 3 is a schematic diagram of another embodiment of the driver circuit according to the invention;

FIG. 4 is a schematic diagram of a conventional driving system for an electroluminescence display panel;

FIG. 5A is a plot showing the conventional charging and discharging process without a charge recycling method;

FIG. 5B is a plot showing the charging and discharging process under a charge recycling method in accordance with an embodiment of the invention;

FIG. 6 illustrates a conventional driving scheme using the pulse-width-modulation (PWM) type grayscale display where selecting voltage signals and driving voltage signals are applied to the display;

FIG. 7 is a plot showing segmented discharging currents and voltages in accordance with an embodiment of the invention;

FIG. 8 is a CMOS circuit implementing the diode and resistor components of FIGS. 2 and 3 according to an embodiment of the invention;

FIG. 9 is a circuit schematics implementing the resistor of FIG. 8 with controllable resistance according to an embodiment of the invention;

FIG. 10 is a circuit schematics providing controllable speed of the discharge process according to an embodiment of the invention;

FIG. 11 is a schematic diagram of a display driver utilizing the circuits in FIGS. 2 and 8 according to an embodiment of the invention; and

FIG. 12 is a block diagram illustrating a connection for multiple power supplies discharge in accordance with an embodiment of the invention.

### DETAILED DESCRIPTION

The present invention enables an effective energy recycling in various situations. The advantages of the invention include:
keeping recycling efficient for any driving scheme and arbitrary display image.
keeping extra circuits small for all applications. Energy flows back from the panel to power supplies and other devices like RAM, MCU directly during the discharging process. Therefore, opposite to the prior art in which extra energy storage circuits, such as a number of big volume capacitors, are required, there is no extra energy storage circuits required in this invention and resulting a small circuit area.
controllable voltage level after discharging and rate of discharging. This makes a design of the present invention be compatible for various applications by just setting some parameters.

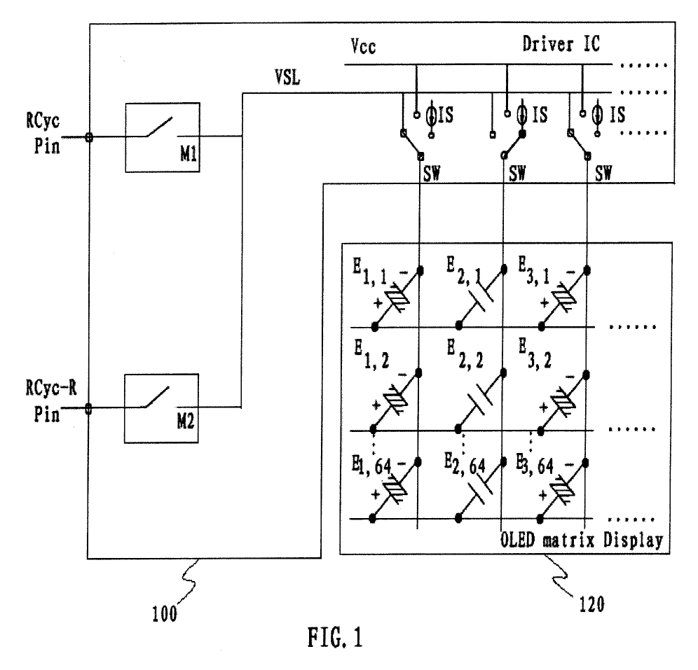

FIG. 1 shows an embodiment of the invention, for being used in a display driver IC 100, comprising a discharging module M1, a discharging module M2, a pin/pad RCyc connected to the module M1, and a pin/pad RCyc-R connected to the module M2. The modules M1 and M2 connect in common to the anode of the OLED matrix display 120. The module M1 controls the discharging path between the anode and the pin RCyc, whereas the module M2 controls the discharging path between the anode and the pin RCycR. The modules M1 and M2 may have different implementations and can be implemented as internal or external circuit of the driver IC 100. The RCyc and RCyc-R pins are connected to different power supplies or ground dependent upon different applications.

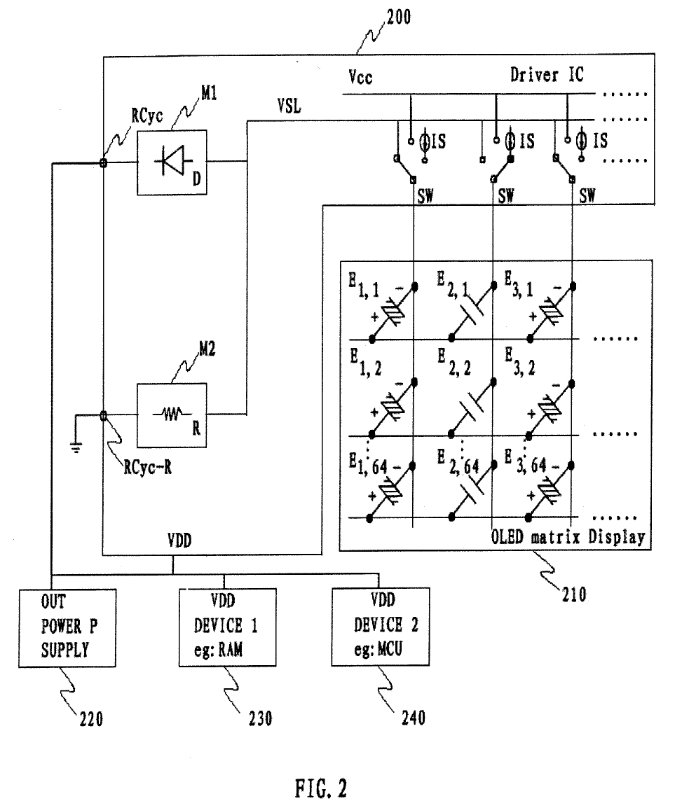

FIG. 2 illustrates an implementation of the present invention. The module M1 is implemented by a diode D, and the module M2 is implemented by a resistor R. Therefore, the discharging path from VSL to RCyc pin is ON (conductive) when VSL (anode voltage)>VRCyc (voltage at pin VRCyc)+VTdiode (threshold voltage of diode D) and OFF (blocked) when VSL<VRCyc+VTdiode, while the discharging path from VSL to RCyc-R pin is always ON. The RCyc pin is connected to a power supply (or battery) 220 and the other power consuming devices 230, 240 powered by this supply 220, such as RAM 230, MCU 240, and the driver IC 200 itself. The supply voltage 220 should be lower than anode voltage VSL of charged EL elements minus threshold voltage VT of the diode. Additionally, the RCyc-R pin can be connected to the ground.

Luminous EL elements may be charged by pre-charge devices (Vcc) and/or current sources (IS) in a charging process. The voltage across luminous EL elements must be reset below a threshold voltage in the following discharging process. The discharging process is started by switching SW from Vcc or IS, to VSL such that the EL element starts discharging through resistor module R to ground (VSS). Discharge current also passes through diode module D to RCyc pin and the power supply P 220 output (VDD), as long as VSL>VDD+VTdiode. This part of the discharge process allows energy recycling which reduces the power delivered from the power supply P 220.

The RCyc pin can be connected to a power supply with supply voltage lower than the EL display threshold voltage minus VTdiode, while RCyc-R pin must be connected to ground or a power supply with supply voltage lower than the display threshold voltage of the EL elements. This requirement guarantees that EL elements are turned off after the discharging process.

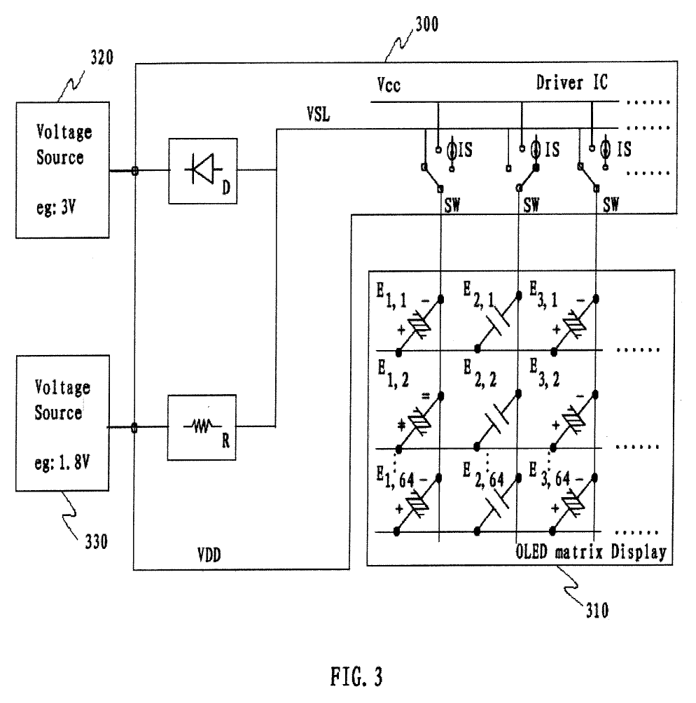

Connecting the RCyc-R pin to a voltage level higher than ground increases the response speed of EL elements because EL elements are charged to illuminate during every charging process from an initial voltage higher than ground. FIG. 3 shows an embodiment of the present invention in which the discharging path resistor is connected to a 1.8V voltage source.

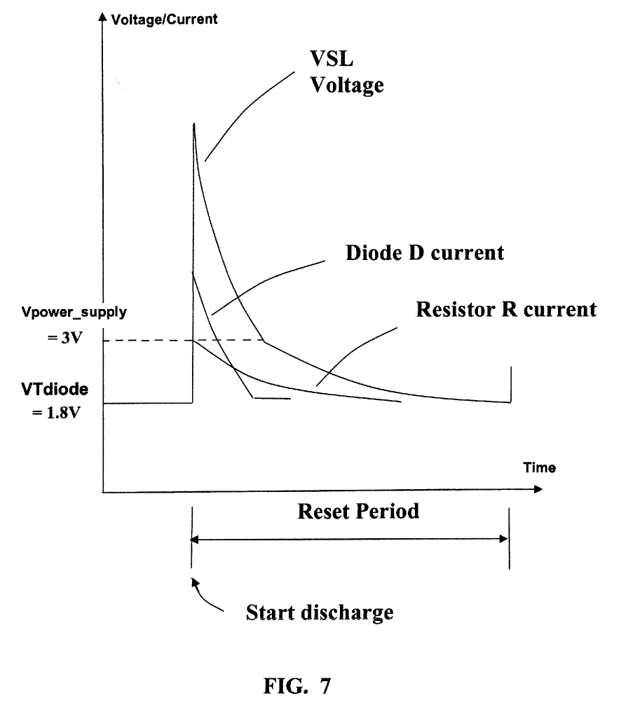

FIG. 7 shows the anode voltage VSL of EL elements, the resistor current, and the diode current in the discharging process. At the beginning, the anode voltage VSL is larger than Vpower_supply+VTdiode. Most of the discharging current (diode D current) flows into the power supply 320 connected to the RCyc pin through the diode module D. When the level of voltage VSL reaches Vpower_supply+VTdiode, the diode D is turned off, and no current passes through the diode module D. Moreover, current/power is not drawn from the power supply 320 to VSL in any case. After the diode D is switched off, the VSL voltage continues to drop by discharging through the resistor R. With a proper resistance value of R, the VSL level drops to a level close to a level well below the voltage VT of EL elements before the end of the reset period.

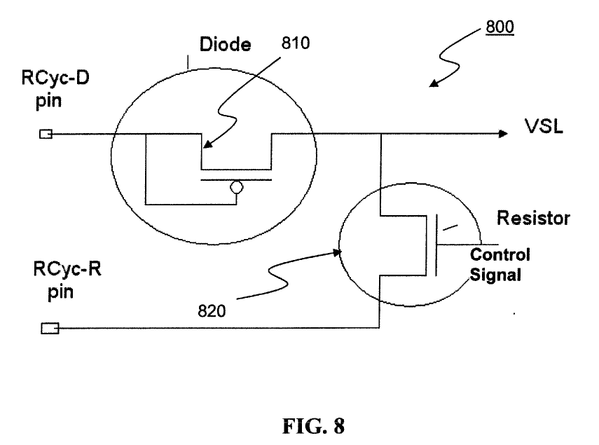

The diode module D and the resistor module R can have different implementations in different processes. FIG. 8 shows a CMOS implementation 800. A PMOS FET 810 is used as a diode with the gate terminal connected to the drain terminal, and an NMOS FET 820 is used as a resistor in the discharging path to ground with the gate terminal connected to a control signal. Other devices structures are also possible for the diode and resistor modules.

To achieve effective power recycling, optimal values of the conductance in the discharging paths are chosen. Optimal values depend on many parameters, including EL panel size and supply voltage Vcc.

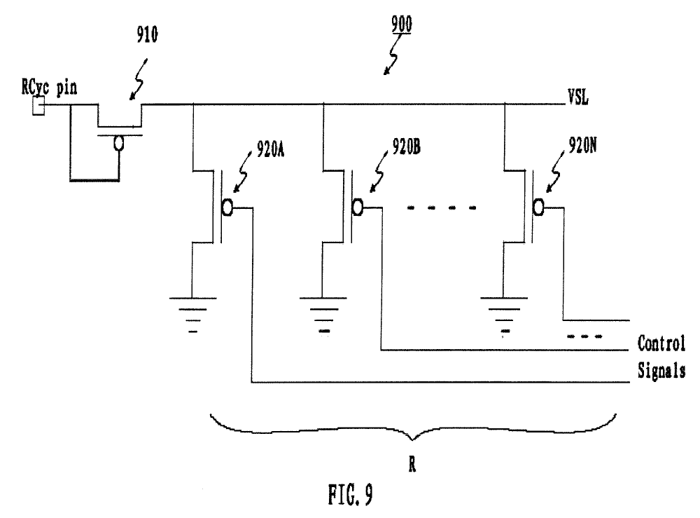

FIG. 9 shows a circuit 900 that provides tunable resistance of the discharge path by using multiple PMOS FETs 920A . . . 920N configured as resistors in parallel as a resistor module R. Effectively, the resistance for the discharging to the RCyc-R pin becomes programmable, dependent on a control signal(s) to suit different application. Use more resistors in this way for faster discharging is desired.

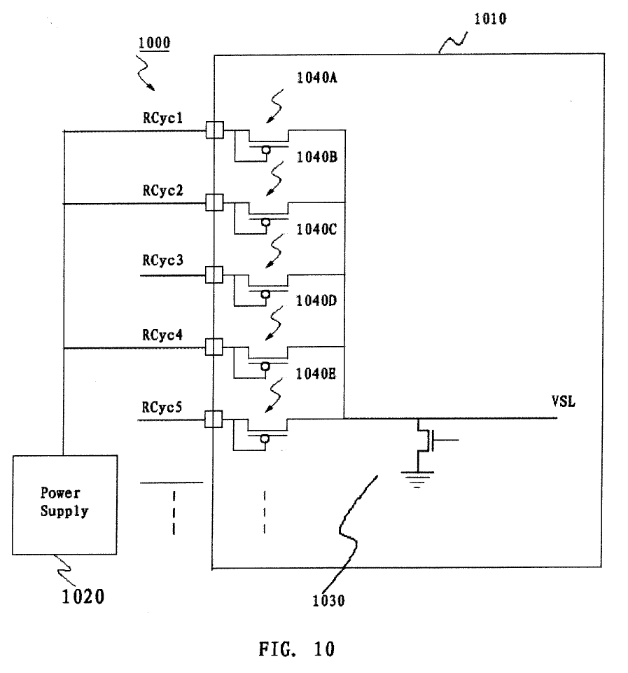

There may be more than one RCyc pin in an implementation and there also can be more than one power supply connected to the RCyc pin(s). Each power supply 1020 can be connected to one or more RCyc pins, as shown in the implementation 1010 in FIG. 10. The connection of multiple diode modules D PMOS FETs 1040A-1040E and so on, and RCyc pins with power supply 1020 provides options in the conductance control of the discharging path to RCYC pins. As more diode modules D are connected to the power supply 1020, the conductance of the discharging path increases and discharge is carried out more quickly through the diodes until the diodes enter off state. Thereafter, discharge continues via NMOS FET 1030, as resistor R, to ground.

In one implementation, all the RCyc pins may be connected to the power supply, and in another implementation only some of the RCyc pins may be connected to the power supply to reduce the conductance. If the power consumption of peripheral devices is low, the amount of recycled power can be reduced by decreasing this diode conductance.

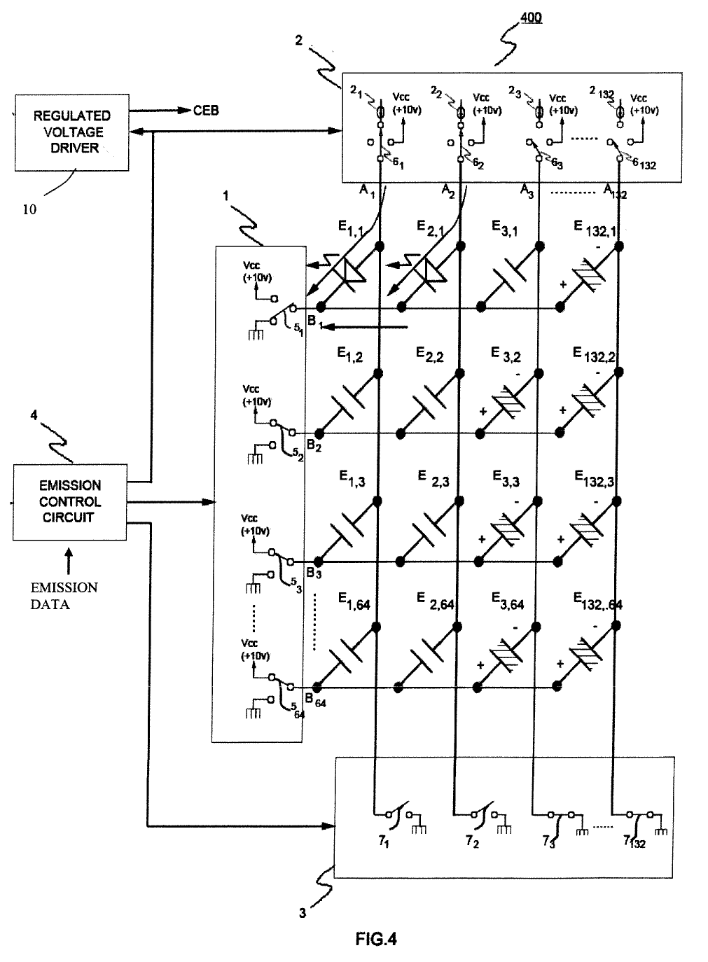

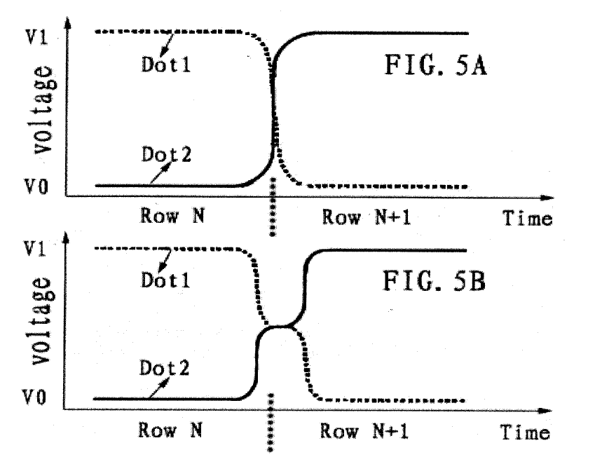

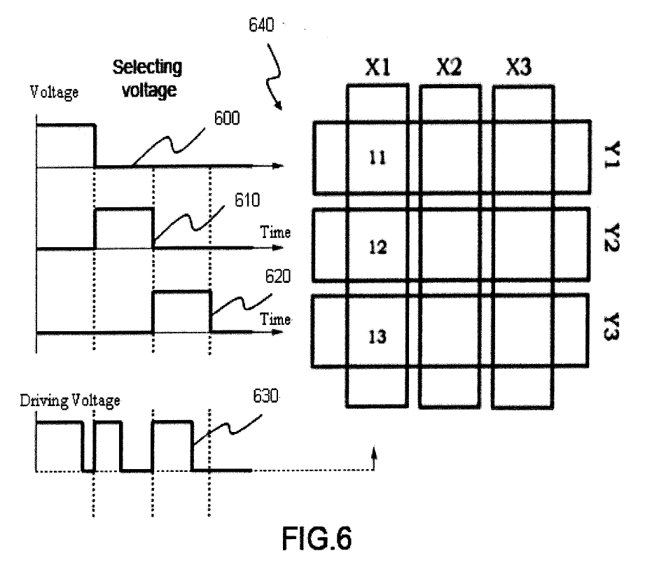

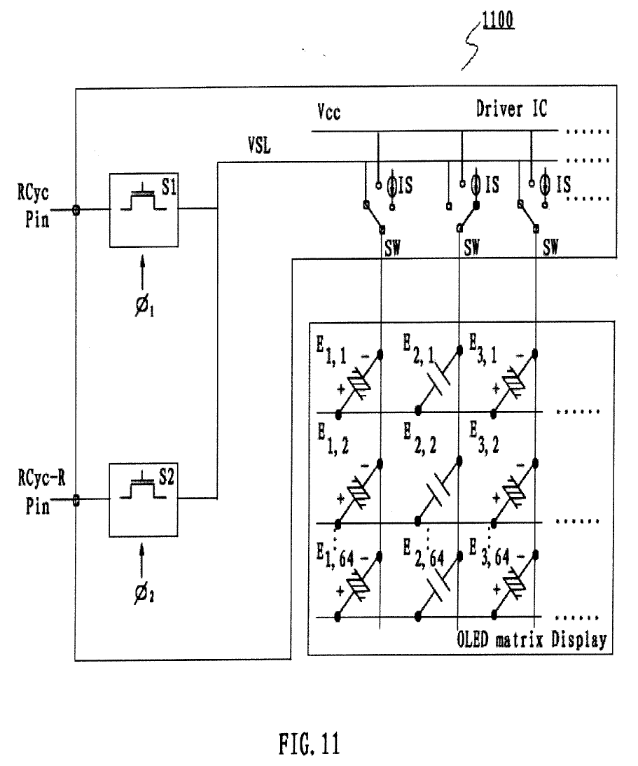

FIG. 11 shows another embodiment of the invention for the driving circuit 1100 with the driver described in FIG. 4. The modules M1 and M2 are implemented by switches S1 and S2 respectively. Extra signals ψ1 and ψ2 control the ON and OFF states of the switches S1 and S2 respectively. When the switch S1 is ON, the switch S2 is OFF, and vise versa. The discharging path from the voltage VSL to RCyc pin is ON when VSL>VRCyc and is OFF when VSL<VRCyc, while the discharging path from anode with voltage VSL to RCyc-R pin is ON only after the voltage VSL drops below VRCyc and is higher than VRCyc-R. This implementation decreases the power loss when the RCyc-R pin is connected to the ground, due to the fact that all power released to ground cannot be recycled. However, the introduction of the control signals ψ1 and ψ2 such as voltage comparators increases the circuit size and complexity. This is a trade-off between power recycling efficiency and circuit simplicity.

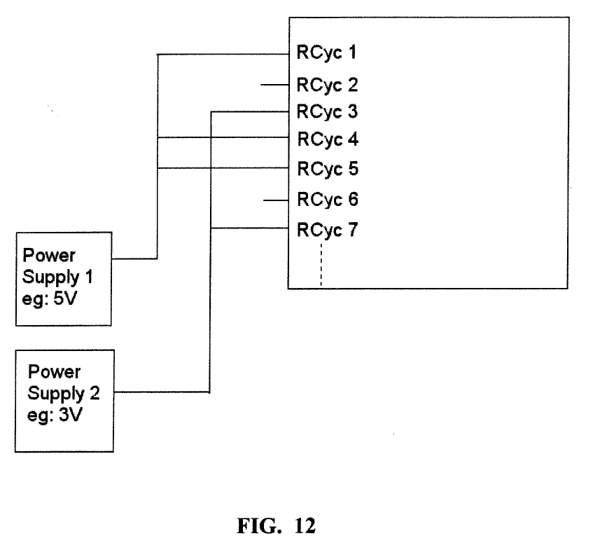

FIG. 12 shows the configuration of connecting RCyc pins with multiple power supplies according to an exemplary embodiment of the present invention. The power supplies connected to the RCyc pins are allowed to have different voltage levels. For example, a power supply with voltage level of 5V is connected to the RCyc pins 1, 4, and 5, while another power supply with voltage level of 3V is connected to the RCyc pins 3 and 7. The Rcyc pins 2 and 6 are floated. As such, the discharge process is divided into more than two segments, during which recycled energy is fed into different power supplies.

In a further embodiment of the invention, the RCyc-R pins in the can also have multiple connections and can be connected to either ground or at least one power supply, as long as the said power supply provides a voltage lower than the display threshold voltage of the OLED display module. The discharging module connected to the RCyc-R pins provides a separate path to discharge the OLED display module apart from the discharge path via the RCyc pins. Such discharging module can be selectively switched ON or OFF by control signals generated from control circuits such as voltage comparators.

### INDUSTRIAL APPLICABILITY

The arrangements described are applicable to power recycling implemented in driving circuits for capacitive display elements such as an OLED display or an electroluminous display, and more particularly to effectively reusing some of the energy otherwise lost during the discharging process.

The foregoing describes only some embodiments of the present invention, and modifications and/or changes can be made thereto without departing from the scope and spirit of the invention, the embodiments being illustrative and not restrictive.

We claim:

1. An apparatus for operating capacitive display element, comprising:
a first discharging module, configured for enabling the discharge of said display element to at least one first power supply when the anode voltage of said display element is greater than voltage of the first power supply; and
for disabling the discharge of said display element to said first power supply when the anode voltage of the display element is lower than the voltage of said first power supply; and
a second discharging module, configured for enabling the discharge of said display element to either ground or at least one second power supply;
wherein said second power supply provides a voltage lower than the display threshold voltage of the display element; said discharge turns off said display element during a phase of driving said display element.

2. The apparatus of claim 1, further comprising an OLED display module for displaying image in accordance with image data to be displayed.

3. The apparatus of claim 1, wherein said first discharging module comprises one discharging element coupled to a first power supply voltage level.

4. The apparatus of claim 1, wherein said first discharging module comprises a number of discharging elements coupling to a number of first power supply voltage levels.

5. The apparatus of claim 1 wherein said second discharging module comprises one discharging element coupled to ground or to said second power supply.

6. The apparatus of claim 4, wherein at least one said discharging element is selected from the group consisting of a diode, a diode-configured MOS device, a MOS switches, and a combination of two or more of the foregoing.

7. The apparatus of claim 4 is wherein at least one said discharging element is selected from the group consisting of a resistor, a resistor-configured MOS device, an MOS switch, and a combination of two or more of the foregoing.

8. A method of driving capacitive display element, comprising:
a first step of discharging current from said display element to at least one first power supply; and
a second subsequent step of discharging current from said display element to at least one second power supply;
wherein said steps of discharging turns off said display element during a phase of driving said display element;
wherein the rate of said first discharging step is faster than the rate of said second discharging step.

9. The method of driving capacitive display element according to claim 8, further comprising a simultaneous third step of discharging current from said display element to said second power supply during said first discharging step.

10. The method of driving capacitive display element according to claim 8, wherein said first discharging step is carried out by discharging through at least one diode means.

11. The method of driving capacitive display element according to claim 8, wherein said second discharging step is carried out by discharging through at least one resistor means.

12. The method of driving capacitive display element according to claim 9, wherein said third discharging step is carried out by discharging through at least one resistor means.

13. The method of driving capacitive display element according to claim 8, wherein said method provides driving to Organic Light-Emitting Diode (OLED) displays or electroluminous (EL) displays.

14. A method of power recycling for an OLED display system, comprising the steps of:
first discharging of an OLED display module from the OLED display threshold voltage to one first power supply level or to a plurality of first power supply voltage levels, wherein the discharging to a plurality of first power supply voltage levels are individually controlled and isolated from each other to maintain integrity of the system power supplies and wherein these voltage levels are below the display threshold voltage of the OLED;
second discharging of the OLED display module from said first power supply level to ground level or to a second power supply voltage level that is lower than the display threshold voltage of the OLED;
wherein said discharging steps turn off the OLED during a phase of driving the display module, and wherein said method achieves power recycling by discharging the electronic charges in the OLED module back to said first power supply and said second power supply in the display system.

15. The method of power recycling for an OLED display system of claim 14, further comprising the step of displaying image on an OLED display module in accordance with image data.

16. The method of power recycling for an OLED display system of claim 14 wherein said first power supply voltage level comprises a plurality of voltage levels from a plurality of power supplies.

17. The method of power recycling for an OLED display system of claim 14 wherein said discharging steps comprise at least one switching on step and one switching off step of the discharging.

18. The method of power recycling for an OLED display system of claim 14 wherein said discharging steps undergo at least one controlled discharge rate.

19. An Organic Light-Emitting Diode (OLED) display system, comprising:
an OLED display module including a plurality of display elements, for displaying image in accordance with image data to be displayed;
a first discharging module including at least one diode means, configured for enabling the discharge of display element to at least one first power supply when the anode voltage of said display element is greater than voltage of the first power supply; and for disabling the discharge of said display element to said first power supply when the anode voltage of the display element is lower than the voltage of said first power supply; and
a second discharging module including at least one resistor means, configured for enabling the discharge of said display element to either ground or at least one second power supply; said second power supply provides a voltage lower than the display threshold voltage of the display element;
said discharge turns off said display element during a phase of driving said display element;
wherein said discharging modules are operable to provide power recycling by discharging the electronic charges in the OLED module back to said first power supply and said second power supply in said display system.
